(19) United States
(12) Patent Application Publication
(10) Pub. No.: US 2016/0341105 A1
(43) Pub. Date: Nov. 24, 2016

(54) SYSTEM FOR SCAVENGING PRE-COMBUSTION CHAMBER

(71) Applicant: Caterpillar Inc., Peoria, IL (US)

(72) Inventor: Yongxian Gu, West Lafayette, IN (US)

(73) Assignee: Caterpillar Inc., Peoria, IL (US)

(21) Appl. No.: 15/230,685

(22) Filed: Aug. 8, 2016

(51) Int. Cl. F02B 19/16; F02B 19/12; F02B 19/10

(52) U.S. Cl. CPC F02B 19/16; F02B 19/10; F02B 19/12

(57) ABSTRACT

In one aspect of the present disclosure, a pre-combustion chamber of an engine is disclosed. The pre-combustion chamber comprises a body having an external surface and an internal surface. The internal surface defines an ignition chamber. The pre-combustion chamber further comprises a first conduit adapted to supply a cold gas on the internal surface of the pre-combustion chamber. The pre-combustion chamber further comprises a second conduit adapted to supply a gaseous fuel into the pre-combustion chamber. The flow of the cold gas is regulated into the pre-combustion chamber to reduce temperature inside the pre-combustion chamber.

### TECHNICAL FIELD

The present disclosure relates to gas engines, and more specifically to a system for scavenging a pre-combustion chamber with a cold gas.

### BACKGROUND

Natural gas engines are widely utilized to perform a variety of applications. Engines that work on alternate fuels, such as natural gas, synthesis gas replace conventional diesel engines in the variety of applications to reduce operating costs of machines. Pre-combustion chambers (also known as pre-chambers) include a combustion volume with a spark plug. The pre-combustion chamber is provided where a fuel, i.e. natural gas may be combined with a portion of air to form a mixture consistently ignitable by the spark plug. The mixture when ignited by the spark plug causes combustion of the very lean mixture of the natural gas and the air within the main cylinder at the optimum time for efficiency and/or pollution control. The spark plug initiates combustion of the natural gas present inside the pre-chamber by generating a spark. The combustion of the natural gas creates a sudden increase in pressure in the pre-chamber, and hence creates a high pressure difference across orifices between the pre-chamber and a main chamber. The high pressure difference enables combusted gas volume to propel through the orifices into the main chamber resulting in a complete combustion of gas volume present in the main combustion chamber. The complete combustion of the natural gas requires a lesser temperature for ignition. However, there are instances when a pre-ignition of the natural gas may occur due to pre-existing high temperature regions within the pre-chamber after the complete combustion of the gas volume. As a result, the engine is subject to uncontrollable often violent combustion, which leads to hardware damages as well as performance deterioration.

PCT Publication Number 2011015329 discloses a method for operating a gas engine. The gas engine comprising a combustion chamber, and a pre-chamber that is temporally connected to the combustion chamber. The gas engine further includes a gas supply and an ignition device. The gas supply feeds fuel gas into the pre-chamber along with the ignition device for igniting the fuel. Further, there is an air supply provided for cooling of the ignition device. However, the arrangement is unable to disclose an arrangement for the cooling of the surface of the pre-chamber for prevention of pre-ignition due high surface temperatures. Therefore, there is a need for an improved system for scavenging the pre-combustion chamber with a cold gas for reducing surface temperatures within the pre-chamber.

### SUMMARY OF THE DISCLOSURE

In one aspect of the present disclosure, a pre-combustion chamber of an engine is disclosed. The pre-combustion chamber comprising a body having an external surface and an internal surface. The internal surface defining an ignition chamber. The pre-combustion chamber further comprises a first conduit adapted to supply a cold gas on the internal surface of the pre-combustion chamber. The pre-combustion chamber further comprises a second conduit adapted to supply a gaseous fuel into the pre-combustion chamber. The flow of the cold gas is regulated into the pre-combustion chamber to reduce temperature inside the pre-combustion chamber.

Other features and aspects of this disclosure will be apparent from the following description and the accompanying drawings.

### BRIEF DESCRIPTION OF THE DRAWINGS

FIG. 1 is a partial side sectional view of an engine cylinder having a pre-combustion chamber, in accordance with the concepts of the present disclosure;

FIG. 2 is an enlarged side sectional view of the pre-combustion chamber of FIG. 1, in accordance with the concepts of the present disclosure; and

FIG. 3 is a flow diagram of a method for scavenging the pre-combustion chamber with a cold gas, in accordance with the concepts of the present disclosure.

### DETAILED DESCRIPTION

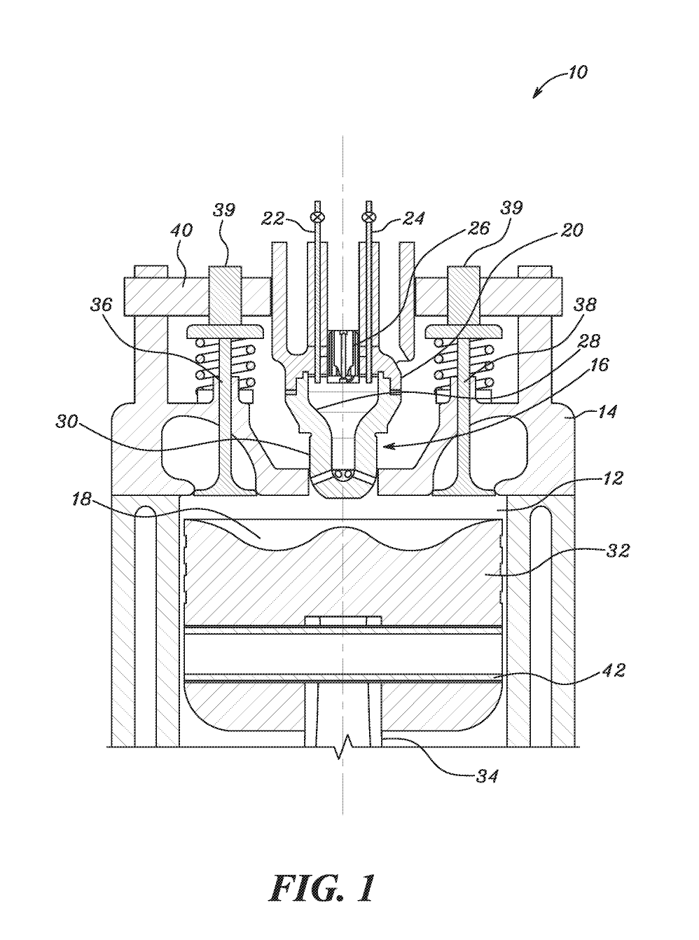

Referring to FIG. 1, a sectional view of a portion of an exemplary engine 10 is illustrated. The engine 10 is a four stroke engine that uses four stroke cycles, i.e. intake stroke, compression stroke, power stroke and exhaust stroke for generating power. Alternatively, the engine 10 may include any other internal combustion engine, such as, a spark ignition engine, a compression ignition engine, a natural gas engine, among others to carry out principles of current disclosure without departing from the meaning and scope of the disclosure. The engine 10 comprises an engine cylinder 12 coupled with a cylinder head 14. The engine cylinder 12 further includes a pre-combustion chamber 16 (also known as pre-chamber 16) and a main combustion chamber 18. The pre-combustion chamber 16 includes a body 20, a first conduit 22, a second conduit 24 and a spark plug 26. The body 20 having an external surface 28 and an internal surface 30. The internal surface 30 defining an ignition chamber. The first conduit 22 is provided to supply a cold gas into the pre-combustion chamber 16 and the second conduit 24 is provided to supply a gaseous fuel into the pre-combustion chamber 16.

The engine 10, houses a piston 32 within the main combustion chamber 18. The piston 32 is connected to a crankshaft (not shown) through a connecting rod 34. It would be apparent to one skilled in the art that the engine 10 has one or more than one engine cylinders 12 for performing four stroke cycles without departing from the meaning and scope of the disclosure. The engine 10 is adapted to move the piston 32 in a reciprocating motion. The piston 32 moves up within the engine cylinder 12 to a top dead center (TDC) position and moves down to a bottom dead center (BDC) position. The crankshaft converts the reciprocating motion of the piston 32 into a rotational motion. The crankshaft is coupled to a flywheel (not shown) The flywheel imparts energy to the crankshaft from time to time in order to keep the crankshaft rotating.

Referring to FIG. 1, the engine cylinder 12 further includes an inlet valve 36 and an exhaust valve 38 to allow entry and exit of a fuel and air mixture respectively in the main combustion chamber 18. A camshaft 40 actuates the opening and closing of the inlet valve 36 and the exhaust valve 38 via cam lobes 39. The camshaft 40 is connected to the crankshaft through a belt (not shown). The belt synchronizes the rotation of the camshaft 40 and the crankshaft to open the inlet valve 36 and close the exhaust valve 38 during an inlet stroke and alternatively close the inlet valve 36 and open the exhaust valve 38 during an exhaust stroke. A gudgeon pin 42 connects the piston 32 and the connecting rod 34. As the piston 32 moves, the gudgeon pin 42 provides a bearing for the connecting rod 34. The engine 10 employs various other components, such as filters, pumps, high pressure release valves, pressure regulators (not shown). It would be apparent to one skilled in the art that the engine 10 is used in a variety of machines such as, but not limited to, excavators, power generators without departing from the meaning and scope of the disclosure.

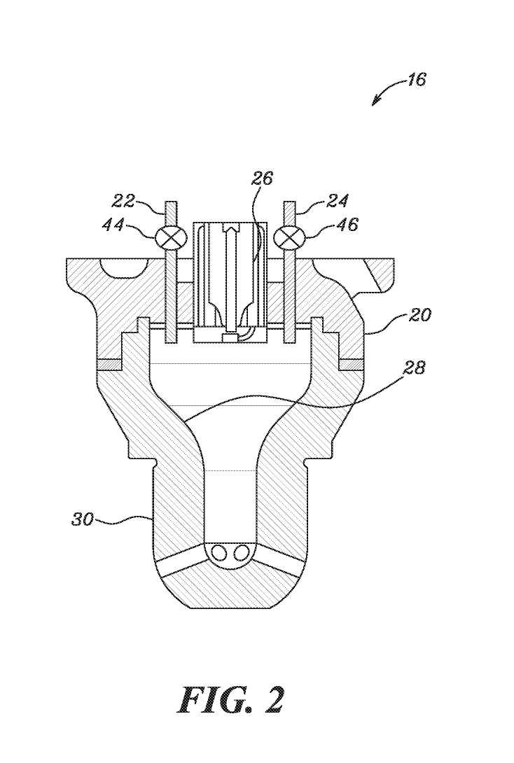

Referring to FIG. 2, the pre-combustion chamber 16 is adapted to receive a cold gas from the first conduit 22 using a first valve 44. It will apparent to one skilled in the art that the cold gas may be atmospheric air, nitrogen or exhaust gas re-circulated at a lower temperature without departing from the meaning and the scope of the disclosure. In an embodiment, the first valve 44 is an electronically controlled valve for regulating the flow of the cold gas into the pre-combustion chamber 16 to reduce the temperature inside the pre-combustion chamber 16 and of the internal surface 30. Further, the reduction in temperature of the internal surface 30 of the pre-combustion chamber 16 prevents pre-ignition which is caused due to high temperature regions present in the pre-combustion chamber 16. The high temperature regions may be present from a last combustion cycle of the engine 10.

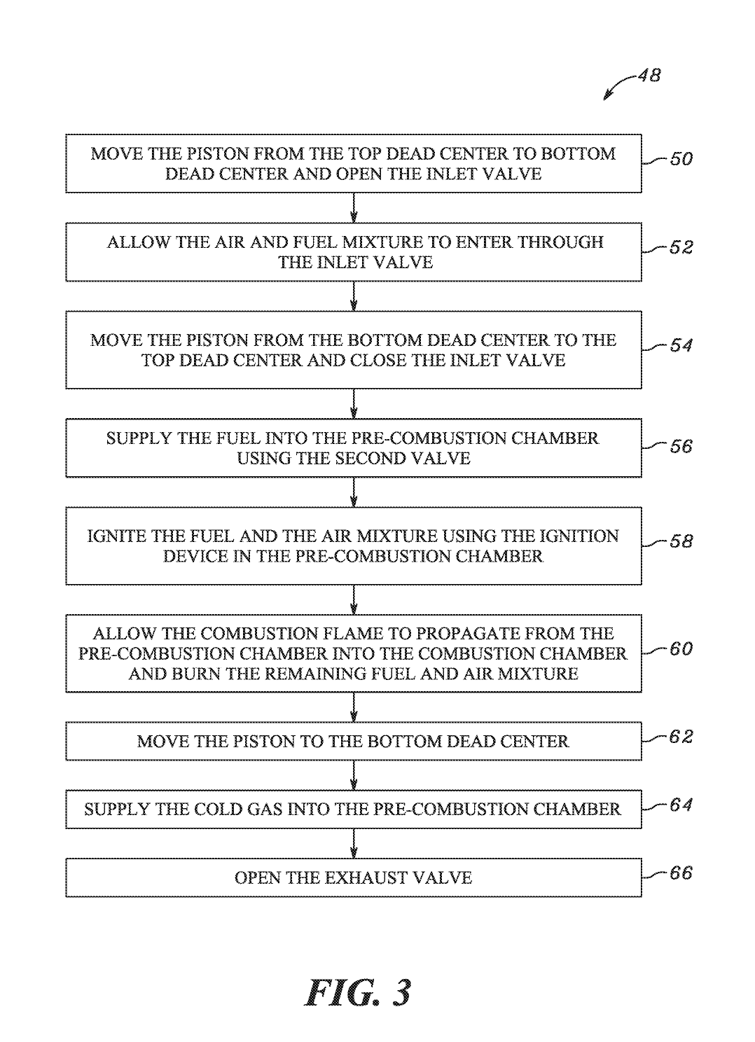

Further, the pre-combustion chamber 16 is adapted to receive a gaseous fuel from the second conduit 24 using a second valve 46. In an embodiment, the second valve 46 is an electronically controlled valve for regarding the flow of the gaseous fuel into the pre-combustion chamber 16 for ignition of the gaseous fuel near to the spark plug 26. In an embodiment, the natural gas supplied to the engine cylinder 12 in a gaseous form. The fuel is an alternate fuel such as natural gas (also called Liquefied Natural Gas (LNG), synthetic gas, liquefied petroleum gas (i.e. LPG), or hydrogen. A mixture of the fuel and the air is ignited by the spark plug 26 within the pre-combustion chamber 16. The spark plug 26 delivers an electric current to ignite the mixture of the fuel and the air within the pre-combustion chamber 16. The detailed combustion process is described in FIG. 3 below.

Aside from the preferred embodiment or embodiments disclosed above, this disclosure is capable of other embodiments and of being practiced or being carried out in various ways. Thus, it is to be understood that the disclosure is not limited in its application to the details of construction and the arrangements of components set forth in the description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

### INDUSTRIAL APPLICABILITY

Referring to FIG. 3, a method 48 for operating the engine 10 is described. The method 48 is described in conjunction with FIG. 1, and FIG. 2.

At step 50, the piston 32 is moved from the top dead center to the bottom dead center in the main combustion chamber 18 of the engine cylinder 12. During this process, the inlet valve 36 is opened.

At step 52, the inlet valve 36 is opened to allow a mixture of the fuel and the air (also called the fuel and air mixture) to enter into the main combustion chamber 18. The piston 32 moves from top dead center to bottom dead center which facilitates the gaseous fuel and air mixture to enter the main combustion chamber 18.

At step 54, the piston 32 moves from the bottom dead center to the top dead center in the main combustion chamber 18. During this cycle, the inlet valve 36 is closed and the mixture of the fuel and the air is received into the main combustion chamber 18. The piston 32 compresses the mixture of the fuel and the air inside the main combustion chamber 18.

At step 56, during the movement of the piston 32 towards the top dead center, the gaseous fuel enters in the pre-combustion chamber 16 via the second valve 46.

At step 58, the mixture of the fuel and the air is ignited using an ignition device, i.e. the spark plug 26 within the pre-combustion chamber 16. The spark plug 26 delivers an electric current to ignite the mixture of the fuel and the air within the pre-combustion chamber 16. As a result, the mixture of the fuel and the air is ignited and a combustion flame gets generated in the pre-combustion chamber 16.

At step 60, the combustion flame then propagates to the main combustion chamber 18 from the pre-combustion chamber 16 via a number of orifices (not shown) and burns the rest of the mixture of the fuel and the air present in the main combustion chamber 18. It would be apparent to one skilled in the art that the injected volume of the gaseous fuel with respect to a total volume may also vary for efficient operation of the engine 10.

At step 62, when the combustion is completed, the piston 32 descends from the top dead center to the bottom dead center. High pressure created by the combustion inside the main combustion chamber 18 drives the piston 32 downward, and thereby supplying power to the crankshaft via the connecting rod 34.

At step 64, the cold gas is supplied into the pre-combustion chamber 16 via the first valve 44 for reduction of temperature on the internal surface 30 of the pre-combustion chamber 16. The exhaust valve 38 is opened to remove the products of combustion and clear the pre-combustion chamber 16 of the engine cylinder 12 to make the engine cylinder 12 ready for the next cycle of combustion.

The engine 10 helps in saving the fuel cost and delivers more customer value. Further, the engine 10 avoids pre-ignition due to the injection of the cold air that reduces the temperature within the pre-combustion chamber 16.

The engine 10 may run at very high power/load as the fuel may be modulated accurately inside the pre-combustion chamber 16 for the combustion. Further, the engine 10 may run on low quality fuel as the fuel is directly supplied to the pre-combustion chamber 16 using the second valve 46 nearer to the spark plug 26.

The engine 10 gains direct control of the pre-combustion chamber 16 as the fuel may be directly supplied to the spark plug 26 for better control of combustion phasing and relative fuel to air ratio. The combustion phasing can be defined as the time in the engine cycle, specifically the compression and expansion strokes, where combustion occurs. Combustion phasing alteration causes a change in combustion duration and may be beneficial in efficient combustion. Further, the combustion speed of the fuel and the air mixture may be controlled. The cold gas through the first valve 44 scavenges and clears up carbon deposits on the internal surface 30 of the pre-combustion chamber 16 and the spark plug 26. The cold gas sprayed from the first valve 44 controls the temperature of the internal surface 30 in order to avoid the pre-ignition of the gaseous fuel and air mixture to prevent knocking and maintain engine efficiency.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A pre-combustion chamber of an engine, the pre-combustion chamber comprising:
a body having an external surface and an internal surface, the internal surface defining an ignition chamber;
a first conduit adapted to supply a cold gas on the internal surface of the pre-combustion chamber; and
a second conduit adapted to supply a gaseous fuel into the pre-combustion chamber;
wherein the flow of the cold gas is regulated into the pre-combustion chamber to reduce temperature inside the pre-combustion chamber.

2. The pre-combustion chamber of claim 1, wherein the first conduit comprises a first valve for regulating the flow of the cold gas.

3. The pre-combustion chamber of claim 1, wherein the second conduit comprises a second valve for regulating the flow of the gaseous fuel.
